(19) United States
(12) Patent Application Publication
(10) Pub. No.: US 2019/0160790 A1
(43) Pub. Date: May 30, 2019

(54) LAMINATED GLASS STRUCTURES WITH OPTICAL CLARITY AND METHODS FOR MAKING THE SAME

(71) Applicant: Corning Incorporated, Corning, NY (US)

(72) Inventors: Jean-Marc Martin Gerard Jouanno, Thomery (FR); Louis Mattos, JR., Painted Post, NY (US)

(21) Appl. No.: 16/098,337

(22) PCT Filed: May 2, 2017
(86) PCT No.: PCT/US17/30554

§ 371 Date: Nov. 1, 2018

Related U.S. Application Data
(60) Provisional application No. 62/330,526, filed on May 2, 2016.

(51) Int. Cl. B32B 17/06; B32B 7/12; B32B 15/12; B32B 15/08; B44C 5/04; B44F 1/06

(52) U.S. Cl. CPC B32B 17/065; B32B 7/12; B32B 15/12; B32B 2307/7246; B32B 15/08; B44C 5/0407; B44F 1/066; B32B 17/064

(57) ABSTRACT

A laminated glass structure is provided that includes a non-glass substrate, a flexible glass sheet, and an adhesive. The non-glass substrate includes one or more layers of polymer-impregnated paper, an upper primary surface and a lower primary surface. The non-glass substrate also comprises an upper moisture barrier at a selected depth from the upper primary surface. The flexible glass sheet has a thickness of no greater than 0.3 mm and is laminated to the upper primary surface of the non-glass substrate with the adhesive. An optional lower moisture barrier can also be included within the non-glass substrate at a selected depth from the lower primary surface. Further, the non-glass substrate may be preconditioned at 70 C for 96 hours or more prior to lamination of the flexible glass sheet to the upper primary surface of the non-glass substrate.

This application claims the benefit of priority to U.S. Application No. 62/330,526, filed May 2, 2016, the content of which is incorporated herein by reference in its entirety.

### FIELD

The present disclosure relates to laminated glass structures and, more particularly, to laminated glass structures and designs configured for optical clarity, adhesive defect resistance, moisture insensitivity and temperature insensitivity.

### BACKGROUND

Laminated glass structures may be used as components in the fabrication of various appliances, automobile components, architectural structures, and electronic devices, to name a few. For example, laminated glass structures may be incorporated as cover glass for various end products such as refrigerators, backsplashes, decorative glazing or televisions. Laminated glass structures can also be employed in decorative wall panels, panels designed for ease-of-cleaning and other laminate applications in which a thin glass surface is valued.

However, laminated glass structures are typically comprised of non-glass substrates, adhesives and glass sheets. In these configurations, laminated glass structures can be particularly sensitive to, changes in temperature and moisture, both of which can result in, or otherwise contribute to defect evolution during manufacture and the lifetime of these structures. For example, bubble defects can develop in the adhesive employed to laminate the glass sheet to the non-glass substrate. These bubbles can originate from residual moisture and other volatiles within and/or moisture ingress into the laminated glass structures resulting from manufacturing and application-specific, environmental exposures. Further, the bubble defects can severely degrade the optical quality of the structure. It is also conceivable that these bubbles can negatively influence the mechanical properties of the adhesive employed to laminate the glass sheet to the non-glass substrate, making the laminated glass structure more susceptible to delamination and/or other failure modes.

Accordingly, there is a need for laminated glass structures and designs with optical clarity, adhesive defect resistance, moisture insensitivity and temperature insensitivity, along with methods of making such structures and designs.

### SUMMARY

According to a first aspect of the disclosure, a laminated glass structure is provided that includes a non-glass substrate, a flexible glass sheet and an adhesive. The non-glass substrate includes one or more layers of polymer-impregnated paper, an upper primary surface and a lower primary surface. The non-glass substrate also comprises an upper moisture barrier at a selected depth from the upper primary surface. The flexible glass sheet has a thickness of no greater than 0.3 mm and is laminated to the upper primary surface of the non-glass substrate with the adhesive.

According to a second aspect, the structure of aspect 1 is provided, wherein the non-glass substrate is preconditioned at 70° C. for 96 hours prior to lamination of the flexible glass sheet to the upper primary surface of the non-glass substrate.

According to a third aspect, the structure of aspect 1 or 2 is provided, wherein the adhesive is substantially defect free upon exposure of the laminated glass structure to a drying evolution at 70° C. for 15 days.

According to a fourth aspect, the structure of any one of aspects 1-3 is provided, wherein the adhesive is substantially defect free upon exposure of the laminated glass structure to ambient humidity and temperature for 60 days.

According to a fifth aspect, the structure of any one of aspects 1-4 is provided, wherein the upper moisture barrier comprises an aluminum foil having a thickness from about 20 to about 60 microns.

According to a sixth aspect, the structure of any one of aspects 1-4 is provided, wherein: the upper moisture barrier has a thickness from about 20 to about 60 microns; the upper moisture barrier comprises a material selected from the group consisting of a glass, a polymer, a metal, a ceramic, and a combination thereof; and the upper moisture barrier exhibits a moisture diffusivity of no more than 10,000 times the moisture diffusivity of the flexible glass sheet at 45° C.

According to a seventh aspect, the structure of any one of aspects 1-6 is provided, wherein the non-glass substrate further comprises a plurality of polymer-impregnated papers.

According to an eighth aspect, the structure of any one of aspects 1-7 is provided, wherein a total thickness of the non-glass substrate, the flexible glass sheet and the adhesive is from about 4 mm to about 25 mm.

According to a ninth aspect, the structure of any one of aspects 1-8 is provided, wherein the upper and lower primary surfaces each comprise a melamine-impregnated decorative layer.

According to a tenth aspect, the structure of any one of aspects 1-9 is provided, wherein the non-glass substrate further comprises an upper portion in proximity to the upper primary surface and a lower portion in proximity to the lower primary surface, and the upper portion exhibits lower moisture diffusivity than the moisture diffusivity of the lower portion.

According to an eleventh aspect of the disclosure, a laminated glass structure is provided that includes a non-glass substrate, a flexible glass sheet and an adhesive. The non-glass substrate includes one or more layers of polymer-impregnated paper, an upper primary surface and a lower primary surface. The non-glass substrate also comprises a lower moisture barrier at a selected depth from the lower primary surface and an upper moisture barrier at a selected depth from the upper primary surface. The flexible glass sheet has a thickness of no greater than 0.3 mm and is laminated to the upper primary surface of the non-glass substrate with the adhesive. Further, the adhesive is substantially defect free upon exposure of the laminated glass structure to a drying evolution at 70° C. for 15 days.

According to a twelfth aspect, the structure of aspect 11 is provided, wherein the non-glass substrate is preconditioned at 70° C. for 96 hours prior to lamination of the flexible glass sheet to the upper primary surface of the non-glass substrate.

According to a thirteenth aspect, the structure of aspect 11 or 12 is provided, wherein the adhesive is substantially defect free upon exposure of the laminated glass structure to ambient humidity and temperature for 60 days.

According to a fourteenth aspect, the structure of any one of aspects 11-13 is provided, wherein the upper and the lower moisture barrier comprises an aluminum foil having a thickness from about 20 to about 60 microns.

According to a fifteenth aspect, the structure of any one of aspects 11-13 is provided, wherein: each of the upper and the lower moisture barriers has a thickness from about 20 to about 60 microns; each of the upper and the lower moisture barriers comprises a material selected from the group consisting of a glass, a polymer, a metal, a ceramic, and a combination thereof; and each of the upper and the lower moisture barriers exhibits a moisture diffusivity of no more than 10,000 times the moisture diffusivity of the flexible glass sheet at 45° C.

According to a sixteenth aspect, the structure of any one of aspects 11-15 is provided, wherein the non-glass substrate further comprises a plurality of polymer-impregnated papers.

According to a seventeenth aspect, the structure of any one of aspects 11-16 is provided, wherein a total thickness of the non-glass substrate, the flexible glass sheet and the adhesive is from about 4 mm to about 25 mm.

According to an eighteenth aspect, the structure of any one of aspects 11-17 is provided, wherein the upper and lower primary surfaces each comprise a melamine-impregnated decorative layer.

According to a nineteenth aspect, the structure of any one of aspects 11-18 is provided, wherein the non-glass substrate further comprises an upper portion in proximity to the upper primary surface and a lower portion in proximity to the lower primary surface, and the upper portion exhibits a lower moisture diffusivity than the moisture diffusivity of the lower portion.

According to a twentieth aspect, a laminated glass structure is provided that includes a non-glass substrate, a flexible glass sheet and an adhesive. The non-glass substrate includes a high pressure laminate (HPL), an upper primary surface and a lower primary surface. The non-glass substrate also comprises an upper moisture barrier at a selected depth from the upper primary surface. The flexible glass sheet has a thickness of no greater than 0.3 mm and is laminated to the upper primary surface of the non-glass substrate with the adhesive. The upper moisture barrier also has a thickness from about 20 microns to about 60 microns. A total thickness of the non-glass substrate, the flexible glass sheet and the adhesive is from about 4 mm to about 25 mm. Further, the adhesive is substantially defect free upon exposure of the laminated glass structure to (a) a drying evolution at 70° C. for 15 days; and (b) ambient humidity and temperature for 60 days.

According to a twenty-first aspect, the structure of aspect 20 is provide, wherein the non-glass substrate is preconditioned at 70° C. for 96 hours prior to lamination of the flexible glass sheet to the upper primary surface of the non-glass substrate.

According to a twenty-second aspect, the structure of aspect 20 or 21 is provided, wherein the upper moisture barrier comprises an aluminum foil.

According to a twenty-third aspect, the structure of any one of aspects 20-22 is provided, wherein: the upper moisture barrier comprises a material selected from the group consisting of a glass, a polymer, a metal, a ceramic, and a combination thereof; and the upper moisture barrier exhibits a moisture diffusivity of no more than 10,000 times the moisture diffusivity of the flexible glass sheet at 45° C.

According to a twenty-fourth aspect, the structure of any one of aspects 20-23 is provided, wherein the upper and lower primary surfaces each comprise a melamine-impregnated decorative layer.

According to a twenty-fifth aspect, the structure of any one of aspects 20-24 is provided, wherein the non-glass substrate further comprises an upper portion in proximity to the upper primary surface and a lower portion in proximity to the lower primary surface, and the upper portion exhibits lower moisture diffusivity than the moisture diffusivity of the lower portion.

According to a twenty-sixth aspect, a method of making a laminated glass structure is provided that includes the step: preconditioning a non-glass substrate at 70° C. for at least 96 hours to define a preconditioned, non-glass substrate, the non-glass substrate comprising a stack of polymer-impregnated papers and an upper moisture barrier, and having an upper primary surface and a lower primary surface. The method also includes the step: laminating a flexible glass sheet having a thickness of no greater than 0.3 mm to the upper primary surface of the preconditioned, non-glass substrate with an adhesive to form the laminated glass structure. Further, the upper moisture barrier is at a selected depth from the upper primary surface of the preconditioned, non-glass substrate.

According to twenty-seventh aspect, the method of aspect 26 is provided that further includes the step: laminating a stack of polymer-impregnated papers at an above-ambient pressure to form the non-glass substrate.

According to a twenty-eighth aspect, the method of aspect 26 or 27 is provided, wherein the step of laminating the flexible glass sheet is conducted no more than 4 days after completion of the preconditioning step.

According to a twenty-ninth aspect, the method of any one of aspects 26-28 is provided, wherein the adhesive is substantially defect free upon exposure of the laminated glass structure to a drying evolution at 70° C. for 15 days.

According to a thirtieth aspect, the method of any one of aspects 26-29 is provided, wherein the adhesive is substantially defect free upon exposure of the laminated glass structure to ambient humidity and temperature for 60 days.

According to a thirty-first aspect, the method of any one of aspects 26-30 is provided, wherein the upper moisture barrier comprises an aluminum foil having a thickness from 20 to about 60 microns.

According to a thirty-second aspect, the method of any one of aspects 26-31 is provided, wherein a total thickness of the preconditioned, non-glass substrate, the flexible glass sheet and the adhesive is from about 4 mm to about 25 mm.

Additional features and advantages will be set forth in the detailed description which follows, and in part will be readily apparent to those skilled in the art from the description or recognized by practicing the disclosure as exemplified in the written description and the appended drawings. It is to be understood that both the foregoing general description and the following detailed description are merely exemplary of the disclosure, and are intended to provide an overview or framework to understanding the nature and character of the disclosure as it is claimed.

The accompanying drawings are included to provide a further understanding of principles of the disclosure, and are incorporated in and constitute a part of this specification. The drawings illustrate one or more embodiment(s), and together with the description serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 illustrates a cross-sectional view of a conventional laminated glass structure;

FIG. 1A illustrates the conventional laminated glass structure depicted in FIG. 1, as experiencing bubble defect formation within its adhesive associated with moisture and temperature;

FIG. 2 illustrates a cross-sectional view of an embodiment of a laminated glass structure with an upper moisture barrier in accordance with aspects of the disclosure;

FIG. 2A illustrates an exploded, cross-sectional view of a laminated glass structure with an upper moisture barrier in accordance with aspects of the disclosure;

FIG. 3 illustrates a cross-sectional view of an embodiment of a laminated glass structure with an upper and a lower moisture barrier in accordance with aspects of the disclosure; and

FIG. 3A illustrates an exploded, cross-sectional view of the laminated glass structure with an upper and a lower moisture barrier in accordance with aspects of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As also used herein, the term “moisture diffusivity” can be used interchangeably with “water vapor transmission rate.” Further, water vapor transmission rate (WVTR) can be measured with ASTM F1249-13 “Standard Test Method for Water Vapor Transmission Rate Through Plastic Film and Sheeting Using a Modulated Infrared Sensor” or ASTM E398-13 “Standard Test Method for Water Vapor Transmission Rate of Sheet Materials Using Dynamic Relative Humidity Measurement,” both of which are hereby incorporated by reference within this disclosure.

Disclosed herein are various laminated glass structures and designs with optical clarity, adhesive defect resistance, moisture insensitivity and/or temperature insensitivity. In general, these laminated glass structures include a non-glass substrate and a flexible glass sheet laminated to the substrate with an adhesive. The non-glass substrate comprises a moisture balancing material, element or barrier at or near the glass side of the non-glass substrate within the laminated glass structure to decrease the rate of moisture ingress or egress (along with ingress or egress of other volatiles) on this side of the structure. The non-glass substrate can comprise a similar or identical moisture balancing material, element or barrier at or near the non-glass side of the non-glass substrate within the laminated glass structure. Further, the non-glass substrate can be preconditioned, dried or otherwise processed to remove residual moisture and other volatiles prior to lamination with the adhesive. By selecting or otherwise positioning a balancing element within the non-glass substrate such that it exhibits a moisture diffusivity that is comparable to or less than the moisture diffusivity through the flexible glass sheet, defects such as bubbles and voids in the adhesive within the overall laminated glass structure can be eliminated or otherwise reduced to an acceptable level in the laminated glass structure as-manufactured and through its lifetime. Likewise, by preconditioning the non-glass substrate such that it has a reduced moisture level prior to lamination with a glass sheet, the propensity for defects to form in the adhesive during lamination and/or subsequent environmental exposure is reduced. Still further, portions of the non-glass substrate on the glass side of the laminated glass structure, or all of the non-glass substrate, can be subjected to compositional modifications to reduce moisture diffusivity to decrease the rate of moisture ingress and egress on this side of the structure near the adhesive with the same or similar benefits as the inclusion of a moisture balancing element or barrier and/or preconditioning the non-glass substrate.

The foregoing moisture balancing (and other volatile balancing) approaches, whether by moisture balancing elements and barriers, by compositional adjustments, non-glass substrate preconditioning, or by combinations of these approaches, offer significant advantages to the laminated glass structures of the disclosure. For instance, these approaches can be tailored to the composition and moisture diffusivity of the flexible glass sheet employed in the laminated glass structure, facilitating design flexibility and manufacturability. Further, the moisture barriers, and any compositional modifications to the non-glass substrate, are generally hidden within the non-glass substrate, allowing both sides of the laminated glass structure to be fabricated with decorative surface features. In addition, these approaches foster enhanced manufacturability from a product cutting and shaping standpoint. In particular, these approaches do not significantly change the overall dimensions and mechanical properties of the laminated glass structure such that conventional cutting and polishing approaches (e.g., computer numerical control (CNC) machining, handheld routers, circular saws, drills, etc.) may still be employed to prepare the structures into their final product forms, even after lamination of the flexible glass sheet.

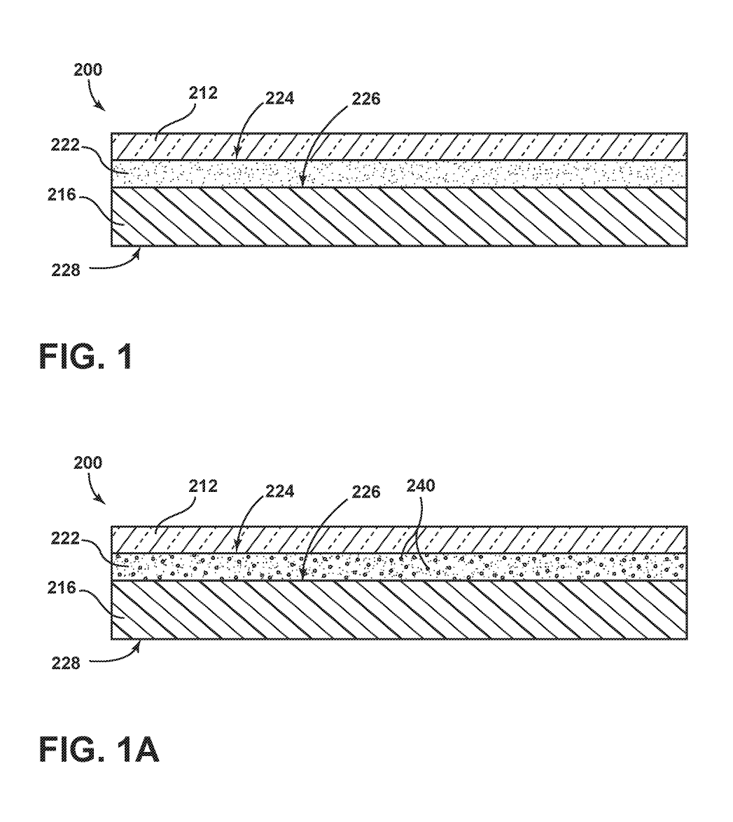

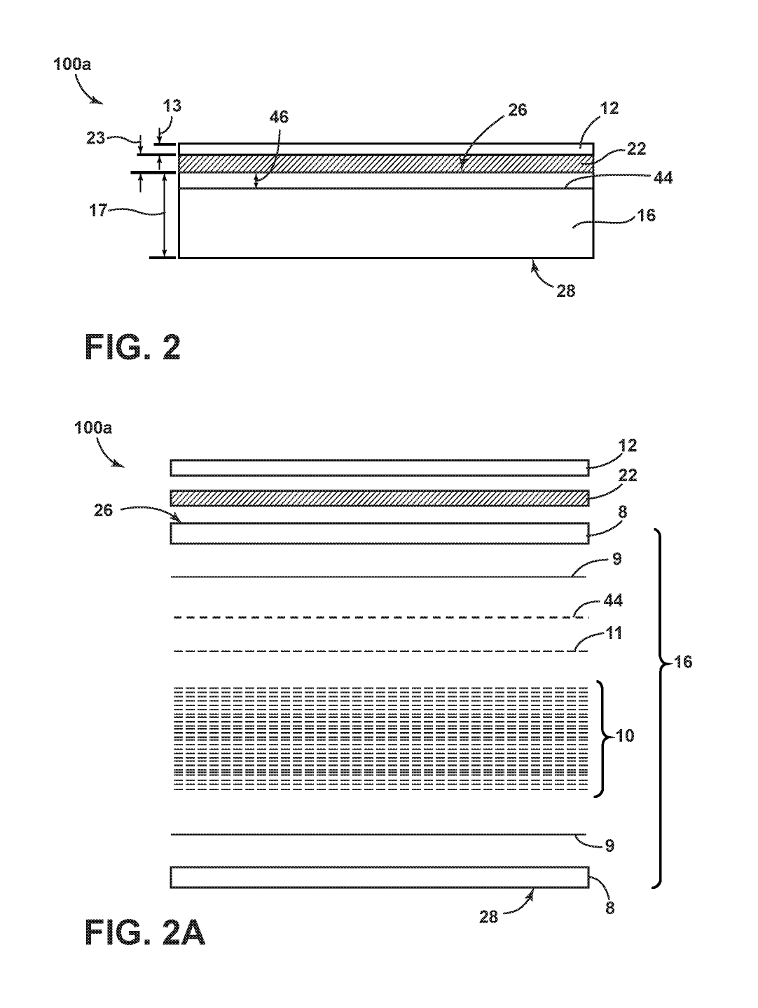

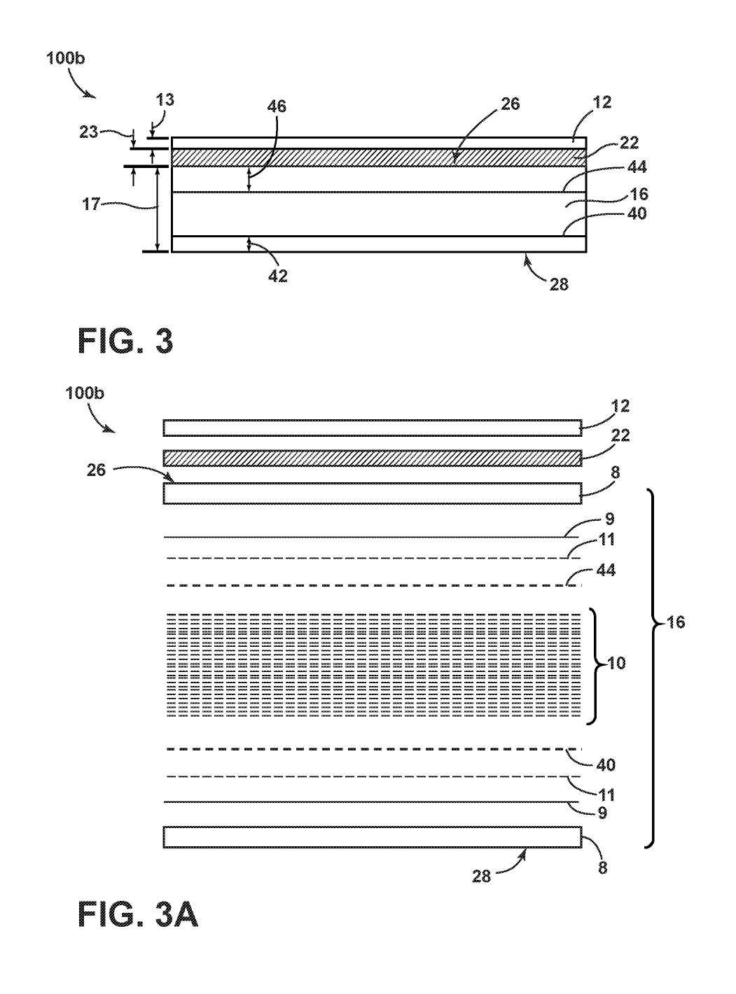

Referring to FIGS. 1 and 1A, a conventional laminated glass structure is depicted to illustrate defect formation problems in the adhesive that are overcome by the laminated glass structures of the disclosure (see, e.g., laminated glass structures 100a, 100b depicted in FIGS. 2, 2A, 3, 3A). A conventional laminated glass structure 200 that includes a glass sheet 212, adhesive 222 and non-glass substrate 216 is illustrated schematically in FIG. 1. A lower primary surface 224 of the glass sheet 212 is laminated to an upper primary surface 226 of the non-glass substrate 216 by the adhesive 222. Further, non-glass substrate 216 is shown with a lower primary surface 228, on the non-glass side of the conventional laminated glass structure 200.

Referring again to FIG. 1, when the glass sheet 212 is laminated to the upper primary surface 226 of the non-glass substrate 216, the resulting laminated glass structure 200 is an unbalanced condition. In particular, the glass sheet 212 forms a hermetic or nearly hermetic barrier over the non-glass substrate 216, which decreases the diffusion rate of water (and other volatiles) into and out of the non-glass substrate 216 through the upper primary surface 226 and through the adhesive 222. As a result, the diffusion rate of water into and out of the lower primary surface 228 and edges of the non-glass substrate 216 is higher than the diffusion rate of water into and out of the upper primary surface 226 and through the adhesive 222.

When the conventional laminated glass structure 200 is exposed to ambient and above-ambient temperatures and/or humidity conditions over a period of hours or days, the non-glass substrate 216 will preferentially dry from the lower primary surface 228 and edges. This can result in the upper primary surface 226 and the adhesive 222 possessing residual moisture (and other volatiles) and/or being prone to moisture ingress at these locations. In turn, the moisture at the upper primary surface 226 and within the adhesive 222 can begin to coalesce into a form visible through the glass sheet 212. As the moisture coalesces, bubbles 240 and other similar defects can begin to form in the adhesive 222 as shown in FIG. 1A, leading to haze, loss in optical clarity and other aesthetic problems for the conventional laminated glass structure 200 as viewed through the glass sheet 212. For example, moisture present in the non-glass substrate 216 can pass into the adhesive 222 via the upper primary surface 226, and when the moisture content within the adhesive 222 exceeds a determined level, the visible bubbles or other defects can form within the adhesive 222.

Referring now to FIG. 2, an exemplary, laminated glass structure 100a is provided according to an embodiment of the disclosure. The laminated glass structure 100a includes a non-glass substrate 16, a flexible glass sheet 12 and an upper moisture barrier 44. The non-glass substrate 16 includes one or more layers of polymer-impregnated paper, an upper primary surface 26 and a lower primary surface 28. The flexible glass sheet 12 has a thickness 13 and is laminated to the upper primary surface 26 of the non-glass substrate 16 with an adhesive 22. The upper moisture barrier 44 is disposed within the non-glass substrate 16 at a selected depth 46 from the upper primary surface 26.

Within the laminated glass structure 100a, the non-glass substrate 16 is primarily comprised of non-glass materials, many of which are hygroscopic and/or susceptible to containing volatiles after manufacturing. Particular examples of the non-glass substrate 16 include but are not limited to wood, fiberboard, laminate, composite, polymeric, metal and/or metal alloy materials. The metal alloys include but are not limited to stainless steel, aluminum, nickel, magnesium, brass, bronze, titanium, tungsten, copper, cast iron, ferrous steels, and noble metals. The non-glass substrate 16 may also include glass, glass-ceramic and/or ceramic materials as secondary constituents, e.g., fillers. In some embodiments, the non-glass substrate 16 includes polymer, wood or wood-based products such as chipboard, particleboard, fiberboard, cardboard, hardboard, or paper. For example, the non-glass substrate 16 comprises a low pressure laminate, a high pressure laminate, and/or a veneer.

In certain implementations, the non-glass substrate 16 can be subjected to preconditioning, drying or another comparable process to reduce or eliminate residual moisture and other volatiles within the non-glass substrate prior to its lamination to the flexible glass sheet 12 with the adhesive 22. As the materials that make up non-glass substrate 16 are often hygroscopic, processed with solvents, and/or emanate volatiles after curing, a preconditioning step can significantly reduce any such residual moisture and/or volatiles prior to a subsequent lamination step that places the flexible glass sheet 12, with its relatively low moisture diffusivity, over the non-glass substrate 16. Accordingly, the preconditioning of the non-glass substrate 16 can reduce the moisture and/or volatiles, which could otherwise coalesce to form defects in the adhesive 12 during further manufacturing and environmental exposure of the laminated glass structure 100a. For example, in certain aspects, the non-glass substrate 16 can be preconditioned at 70° C. for 96 hours prior to the lamination of the non-glass substrate 16 to the flexible glass sheet 12 with the adhesive 22. As those with ordinary skill in the field of the disclosure understand, different preconditioning time and temperature conditions can also be employed to a similar effect, recognizing the size of the non-glass substrate 16, non-glass substrate 16 composition and other factors that could influence the preconditioning kinetics.

As depicted in FIG. 2, the non-glass substrate 16 has a thickness 17 within the laminated glass structure 100a. In certain aspects, the thickness 17 of the non-glass substrate 16 ranges from about 1 mm to about 30 mm. For example, the thickness 17 can be 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm and all thickness values between these thicknesses. In one aspect, the thickness 17 of the non-glass substrate 16 is between about 2 mm and 25 mm.

In certain embodiments of the laminated glass structure 100a, the non-glass substrate 16 may be formed using a polymer material, for example, any one or more of polyethylene teraphthalate (PET), polyethylene Naphthalate (PEN), ethylene tetrafluoroethylene (ETFE), or thermopolymer polyolefin (TPO™—polymer/filler blends of polyethylene, polypropylene, block copolymer polypropylene (BCPP), or rubber), polyesters, polycarbonate, polyvinylbuterate, polyvinyl chloride, polyethylene and substituted polyethylenes, polyhydroxybutyrates, polyhydroxyvinylbutyrates, polyetherimides, polyamides, polyethylenenaphalate, polyimides, polyethers, polysulphones, polyvinylacetylenes, transparent thermoplastics, transparent polybutadienes, polycyanoacrylates, cellulose-based polymers, polyacrylates and polymethacrylates, polyvinylalcohol, polysulphides, polyvinyl butyral, polymethyl methacrylate and polysiloxanes. It is also possible to use polymers which can be deposited and/or coated as pre-polymers or pre-compounds and then converted, such as epoxy-resins, polyurethanes, phenol-formaldehyde resins, and melamine-formaldehyde resins. Many display and electrical applications may prefer acrylic-based polymers, silicones and such structural aiding layers, for example, commercially available SentryGlas® from DuPont. The polymer layers may be transparent for some applications, but need not be for other applications.

Referring again to FIG. 2, the flexible glass sheet 12 may be formed of glass, a glass ceramic, a ceramic material or composites thereof. A fusion process (e.g., a downdraw process) that forms high quality flexible glass sheets can be used in a variety of devices, and one such application is flat panel displays. Glass sheets produced in a fusion process have surfaces with superior flatness and smoothness when compared to glass sheets produced by other methods. The fusion process is described in U.S. Pat. Nos. 3,338,696 and 3,682,609, the disclosures of which are hereby incorporated by reference. Other suitable glass sheet forming methods include a float process, updraw and slot draw methods. Additionally, the flexible glass sheet 12 may also contain anti-microbial properties by using a chemical composition for the glass that includes or otherwise incorporates a silver ion concentration on the surface of the glass sheet, for example, in the range from greater than 0 to 0.047 μg/cm², as further described in U.S. Patent Application Publication No. 2012/0034435, the disclosure of which is hereby incorporated by reference. The flexible glass sheet 12 may also be coated with a glaze composed of silver, or otherwise doped with silver ions, to gain the desired anti-microbial properties, as further described in U.S. Patent Application Publication No. 2011/0081542, the disclosure of which is hereby incorporated by reference. Additionally, the flexible glass sheet 12 may have a molar composition of 50% SiO₂, 25% CaO, and 25% Na₂O to achieve the desired anti-microbial properties.

As depicted in FIG. 2, the flexible glass sheet 12 of the laminated glass structure 100a has a thickness 13. In certain aspects of the laminated glass structure 100a, the thickness 13 of the flexible glass sheet 12 is about 0.3 mm or less including but not limited to thicknesses of, for example, about 0.01-0.05 mm, about 0.05-0.1 mm, about 0.1-0.15 mm, about 0.15-0.3 mm, or about 0.1 to about 0.2 mm. The thickness 13 of the flexible glass sheet 12 can also be about 0.3 mm, 0.275 mm, 0.25 mm, 0.225 mm, 0.2 mm, 0.19 mm, 0.18 mm, 0.17 mm, 0.16 mm, 0.15 mm, 0.14 mm, 0.13 mm, 0.12 mm, 0.11 mm, 0.10 mm, 0.09 mm, 0.08 mm, 0.07 mm, 0.06 mm, 0.05 mm, 0.04 mm, 0.03 mm, 0.02 mm, 0.01 mm, or any thickness value between these thicknesses.

As further depicted in FIG. 2, the laminated glass structure 100a includes an adhesive 22 that can be employed to laminate the flexible glass sheet 12 to the upper primary surface 26 of the non-glass substrate 16. The adhesive 22 may be a non-adhesive interlayer, an adhesive, a sheet or film of adhesive, a liquid adhesive, a powder adhesive, a pressure sensitive adhesive, an ultraviolet-light curable adhesive, a thermally curable adhesive, or other similar adhesive or combination thereof. The adhesive 22 may assist in attaching the flexible glass sheet 12 to the non-glass substrate 16 during lamination. Some examples of low temperature adhesive materials include Norland Optical Adhesive 68 (Norland Products, Inc.) cured by ultra-violet (UV) light, FLEXcon V29TT adhesive, 3M™ optically clear adhesive (OCA) 8211, 8212, 8214, 8215, 8146, 8171, and 8172 (bonded by pressure at room temperature or above), 3M™ 4905 tape, OptiClear® adhesive, silicones, acrylates, optically clear adhesives, encapsulant material, polyurethane polyvinylbutyrates, ethylenevinylacetates, ionomers, and wood glues. Typical graphic adhesives such as Graphicmount and Facemount may also be used (as available from LexJet Corporation, located in Sarasota, Fla., for example). Some examples of higher temperature adhesive materials include DuPont SentryGlas®, DuPont PV 5411, Japan World Corporation material FAS and polyvinyl butyral resin. The adhesive 22 may be thin, having a thickness 23 of less than or equal to about 1000 μm, including less than or equal to about 500 μm, about 250 μm, less than or equal to about 50 μm, less than or equal to 40 μm, and less than or equal to about 25 μm. In other aspects, the thickness 23 of the adhesive 22 is between about 0.1 mm and about 5 mm. The adhesive 22 may also contain other functional components such as color, decoration, heat or UV resistance, AR filtration, etc. The adhesive 22 may be optically clear on cure, or may otherwise be opaque. In embodiments where the adhesive 22 is a sheet or film of adhesive, the adhesive 22 may have a decorative pattern or design visible through the thickness 13 of the flexible glass sheet 12.

As also depicted in FIG. 2, the adhesive 22 of the laminated glass structure 100a can be formed of a liquid, gel, sheet, film or a combination of these forms. Further, in some aspects, the adhesive 22 can exhibit a pattern of stripes that are visible from an outer surface of the flexible glass sheet 12. In some embodiments, the non-glass substrate 16 may provide a decorative pattern and/or the decorative pattern may be provided on either surface of the flexible glass sheet 12. In some embodiments, the decorative pattern may be provided within multiple layers, e.g., within flexible glass sheet 12, non-glass substrate 16 and/or adhesive 22. Some air bubbles may become entrained in the laminated glass structure 100a during or after lamination, but air bubbles having a diameter of equal to or less than 100 μm may not affect the impact resistance of the laminated glass structure 100a. Formation of air bubbles within the structure 100a may be reduced by use of a vacuum lamination system or application of pressure to a surface of the structure 100a during lamination.

Referring again to FIG. 2, the overall thickness of the laminated glass structure 100a can range from about 1 mm to about 35 mm. In particular, the overall thickness of the laminated glass structure 100a is given by the sum of the thicknesses 13, 17 and 23 of the flexible glass sheet 12, non-glass substrate 16 and adhesive 22, respectively. Accordingly, the overall thickness of the laminated glass structure 100a can be about 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, and all thickness values between these overall thicknesses. In certain aspects, the overall thickness of the laminated glass structure 100a can range from about 4 mm to about 25 mm.

The laminated glass structure 100a depicted in FIG. 2 also includes an upper moisture barrier 44. The upper moisture barrier 44 is disposed within the non-glass substrate 16 at a selected depth 46 from the upper primary surface 26. In certain implementations, the selected depth 46 for the upper moisture barrier 44 is about 1 micron to about half of the thickness 17 of the non-glass substrate 16 from the upper primary surface 26 of the non-glass substrate 16. As an example, the upper moisture barrier 44 can have a selected depth 46 of about one fourth of the thickness 17 from the upper primary surface 26. More particularly, the upper moisture barrier 44 can help to decrease the rate of moisture ingress or egress at the upper primary surface 26 of the structure. The laminated glass structure also can include a similar or identical moisture balancing material, element or barrier at or near the non-glass side (i.e., the lower primary surface 28) of the non-glass substrate 16 within the laminated glass structure (see the lower moisture barrier 40 of the laminated glass structure 100b depicted in FIG. 3).

Along with preconditioning the non-glass substrate 16, selecting and/or positioning a moisture barrier, e.g., upper moisture barrier 44, within the non-glass substrate 16 such that it exhibits a moisture diffusivity that is comparable to or less than the moisture diffusivity through the flexible glass sheet 12, serves to eliminate or reduce bubbles and other defects within the adhesive 22 of the overall laminated glass structure 100a to an acceptable level, as-manufactured and through its lifetime. A moisture barrier, e.g., upper moisture barrier 44, that is selected and positioned according to the foregoing principles is effective at eliminating bubbles in the adhesive 22, particularly through the lifetime of the laminated glass structure 100a as it experiences various environmental conditions. Further, an upper moisture barrier 44 is beneficially hidden or otherwise buried within the laminated glass structure 100a such that it does not detract from the aesthetics of the structure, affect its design flexibility in terms of possessing other decorative surfaces (e.g., on the upper primary surface 26), and/or impact the manufacturability and preparation of its final form (e.g., through cutting, sectioning, polishing and the like).

The upper moisture barrier 44 depicted in FIG. 2 can have a thickness that ranges from about 1 micron to about 100 microns. For example, the upper moisture barrier 44 can range in thickness from about 10 to 90 microns, 20 to 80 microns, 30 to 70 microns, 20 to 60 microns, 30 to 50 microns, 35 to 45 microns, about 40 microns, and all thickness values between these ranges. In certain aspects, the upper moisture barrier 44 can be sized for an additional aesthetic function such that it can be viewed edge-on within the laminated glass structure 100a.

Referring again to FIG. 2, the upper moisture barrier 44 can be fabricated from various materials including, but not limited to, a metal, a metal alloy, a glass, a glass-ceramic, a ceramic, a polymer, a composite and/or a combination of these materials. In an exemplary implementation, the upper moisture barrier 44 is fabricated from aluminum or an aluminum alloy in the form of a foil. Aluminum foil can exhibit a water vapor transmission rate (WVTR) of 0.001 g/m²*day or less and, in certain instances, may approach a WVTR of ˜0 g/m²*day, as reported in the open literature. In contrast, the WVTR of polymers, which may be used to fabricate the non-glass substrate 16, is significantly higher as reported in the open literature (e.g., 0.7 to 1.47 g/m²*day for polypropylene and 2.4 to 4 g/m²*day for polyvinyl chloride as measured at 38° C.). In some embodiments, the material (or materials) selected for the upper moisture barrier 44 is chosen to approximate the moisture diffusivity or water vapor transmission rate (WVTR) of the flexible glass sheet 12. For example, the flexible glass sheet 12 can be fabricated from Corning® Willow® Glass, which has been reported in the open literature with a WVTR of <7×10⁻⁶ g/m²*day, as measured at 45° C. In other implementations, the material (or materials) selected for the upper moisture barrier 44 is chosen such that it exhibits a moisture diffusivity of no more than 10,000 times, no more than 1,000 times, or no more than 100 times the moisture diffusivity of the flexible glass sheet 12, e.g., as measured at 45° C.°. Accordingly, certain implementations of the laminated glass structure 100a can incorporate an upper moisture barrier 44 with a moisture diffusivity or WVTR that is greater than or comparable to the moisture diffusivity of the flexible glass sheet 12, while much lower than bulk of the materials employed in the non-glass substrate 16.

With regard to optical clarity, adhesive defect resistance, moisture insensitivity and temperature insensitivity, the laminated glass structure 100a depicted in FIG. 2 can be characterized by various attributes. For example, certain implementations of the laminated glass structure 100a are characterized by an adhesive 22 that is substantially defect or bubble free upon exposure of the laminated glass structure to a drying evolution or a condition of 70° C. for 15 days. In some embodiments, the substantially defect free condition of the adhesive 22 exists after exposure to a 70° C. drying evolution of 70° C. for 1 day, 2 days, 3 days, 4 days, 5 days, 6 days, 7 days, 8 days, 9 days, 10 days, 11 days, 12 days, 13 days, 14 days, 15 days, and all durations between these periods.

As used herein, “substantially defect free” refers to a condition in which virtually no defects are visible with the naked eye through the glass sheet of the laminated glass structure. More particularly, “substantially defect free” laminated glass structures are defined as having no more than 3 visible bubbles/m², wherein a visible bubble satisfies the equation 1.0 mm<Ø≤2.5 mm, in which Ø is the diameter of the bubble as given by Ø=(max L+max W)/2, and max L and max Ware the maximum measured length and width dimensions of the bubble, respectively. To clarify, “substantially defect free” laminated glass structures allow for bubbles with Ø≤1.0 mm. Further, all visible bubbles must be separated by greater than 300 mm. Finally, all measurements made in the “substantially defect free” determination are performed by an inspector on the laminated glass structure using a 1700 lux fluorescent light at a distance of 1 m from the structure.

Other implementations of the laminated glass structure 100a depicted in FIG. 2 are characterized by an adhesive 22 that is substantially defect or bubble free upon exposure to ambient temperature and humidity for 60 days. In some embodiments, the substantially defect free condition of the adhesive 22 exists after ambient temperature and humidity exposure of 1 day, 2 days, 3 days, 4 days, 5 days, 10 days, 15 days, 20 days, 25 days, 30 days, 35 days, 40 days, 45 days, 50 days, 55 days, 60 days, and all durations between these periods.

As used herein, “bubbles,” “voids,” “defects” and “adhesive defects” are used interchangeably to denote defects in the adhesive, in proximity to the adhesive and/or of the surfaces of the adhesive employed in the laminated glass structures of the disclosure. Further, these adhesive defects are visible to the naked eye under ambient lighting conditions through the glass sheet laminated to an underlying non-glass substrate with the adhesive. Still further, these adhesive defects are distinct from the “air bubbles” referenced earlier within the laminated glass structures insofar as the “adhesive defects” are associated with moisture and other volatiles within the non-glass substrate, develop after manufacturing is complete, and cannot be controlled through mere adjustment of mechanical forces, including vacuum apparatus, during lamination procedures.

Referring now to FIG. 2A, another exemplary embodiment of a laminated glass structure 100a is depicted in the form a laminated glass structure having a high-pressure laminate (HPL). Unless otherwise noted, the laminated glass structure 100a depicted in FIG. 2A includes the same features as the laminated glass structure 100a depicted in FIG. 2. For example, the laminated glass structure 100a shown in FIG. 2A includes a non-glass substrate 16, a flexible glass sheet 12 and an upper moisture barrier 44. Further, the laminated glass structure 100a shown in FIG. 2A can exhibit the same functionality as the structure 100a depicted in FIG. 2, including optical clarity, adhesive defect resistance, moisture insensitivity and/or temperature insensitivity. In particular, the adhesive 22 of the laminated glass structure 100a is substantially defect free upon exposure to (a) a drying evolution at 70° C. for 15 days; and (b) ambient humidity and temperature for 60 days. However, the non-glass substrate 16 of the laminated glass structure 100a depicted in FIG. 2A more particularly includes a stack 10 of polymer-impregnated papers, an upper moisture barrier 44, polymer-impregnated decorative papers 9, a separate polymer-impregnated paper 11 and optional surface layers 8. In this configuration, the polymer-impregnated paper 11 is configured to assist or otherwise enable the joining of the polymer-impregnated decorative paper 9 to the upper moisture barrier 44. Still further, the non-glass substrate 16 is preconditioned at 70° C. for 96 hours prior to lamination of the upper primary surface 26 of the non-glass substrate 16 with the adhesive 22 to the flexible glass sheet 12.

In some embodiments, the laminated glass structure 100a has an overall thickness from about 4 mm to about 25 mm, and includes a non-glass substrate 16 in the form of an HPL with a stack 10 having about 1 to 100 phenolic resin-impregnated kraft papers, laminated under an above-ambient pressure. The upper moisture barrier 44 is in the form of an aluminum foil ranging in thickness from about 20 to 60 microns. Further, each of the polymer-impregnated decorative papers 9 is configured as a melamine-impregnated decorative kraft paper. As such, each of the papers 9 can include a solid color and/or decorative patterns. When patterns are employed in the decorative papers 9, an additional melamine-impregnated surface layer 8 can be added to the HPL to ensure that wear to the HPL does not result in a loss or degradation to the pattern(s) contained in the papers 9. Conversely, the surface layers 8 are unnecessary to include in the HPL for decorative papers 9 containing a solid color decorative aspect.

According to a further aspect of the laminated glass structures 100a depicted in FIGS. 2 and 2A, portions of the non-glass substrate 16 on the glass side (i.e., upper primary surface 26) of the laminated glass structure, or all of the non-glass substrate 16, can be subjected to compositional modifications to reduce moisture diffusivity. In particular, the upper portion of the non-glass substrate 16, or all of the non-glass substrate 16, can be modified to decrease the rate of moisture ingress and egress on the side of the laminated glass structure 100a in close proximity to the flexible glass sheet 12. The net result is that the laminated glass structure 100a can obtain the same or similar benefits as the inclusion of the upper moisture barrier 44 in terms of adhesive optical clarity, adhesive defect resistance, moisture insensitivity and/or temperature insensitivity. Further, in some embodiments, these modifications can be made to a laminated glass structure 100a containing the upper moisture barrier 44 to further enhance its optical clarity, adhesive defect resistance, moisture insensitivity and/or temperature insensitivity.

By way of example only, the density of the stack 10 of the laminated glass structure 100a depicted in FIG. 2A can be modified to make it less susceptible to changes in moisture and/or temperature associated with subsequent processing of the laminated glass structure and/or environmental conditions associated with the structure. In particular, a stack 10 that includes a plurality of phenolic resin-impregnated kraft papers can be modified by increasing the formaldehyde to phenolic resin ratio and/or curing the stack 10 at a higher temperature (e.g., at 145 to 150° C. compared to 135 to 140° C. for a non-modified stack 10). The resulting stack 10 is expected to have a higher degree of cross-linking and, accordingly, a higher density and lower moisture diffusivity. As such, the lower moisture diffusivity associated with the stack 10 beneath the flexible glass sheet 12 can serve to balance or otherwise equilibrate the moisture ingress and egress within the laminated glass structure 100a, as containing an upper moisture barrier 44, a lower moisture barrier 40 (see FIGS. 3 and 3A) or no embedded moisture barriers.

Referring now to FIG. 3, an exemplary, laminated glass structure 100b is provided according to an embodiment of the disclosure. Unless otherwise noted, the laminated glass structure 100b depicted in FIG. 3 has the same or similar features and capabilities (i.e., bow resistance, moisture insensitivity and temperature insensitivity) as the laminated glass structure 100a depicted in FIG. 2. Further, like-numbered elements in the laminated glass structures 100a and 100b have the same or similar structures and functions. As shown in FIG. 3, the laminated glass structure 100b includes a non-glass substrate 16, a flexible glass sheet 12, a lower moisture barrier 40 and an upper moisture barrier 44. The non-glass substrate 16 includes one or more layers of polymer-impregnated paper, an upper primary surface 26 and a lower primary surface 28. The flexible glass sheet 12 has a thickness 13 and is laminated to the upper primary surface 26 of the non-glass substrate 16 with an adhesive 22. The lower moisture barrier 40 is disposed within the non-glass substrate 16 at a selected depth 42 from the lower primary surface 28. Further, the upper moisture barrier 44 is disposed within the non-glass substrate 16 at a selected depth 46 from the upper primary surface 26.

The laminated glass structure 100b depicted in FIG. 3 includes a lower moisture barrier 40 and an upper moisture barrier 44. The lower moisture barrier 40 is disposed within the non-glass substrate 16 at a selected depth 42 from the lower primary surface 28. The upper moisture barrier 44 is disposed within the non-glass substrate 16 at a selected depth 46 from the upper primary surface 26. In certain implementations, the selected depths 42 and 46 for the moisture barriers 40, 44 are, independently, about 1 micron to about half of the thickness 17 of the non-glass substrate 16. In some embodiments, the moisture barriers 40, 44 are equidistant from each other and the upper and lower primary surfaces 26, 28 of the non-glass substrate 16. According to one implementation, the moisture barriers 40, 44 are set at substantially equivalent selected depths 42, 46, respectively, from the respective primary surfaces 28, 26 of the non-glass substrate 16. More particularly, the lower and upper moisture barriers 40, 44 are added to the non-glass substrate 16 within the laminated glass structure 100b to decrease the rate of moisture ingress or egress on the side of the structure away from the flexible glass sheet 12 (i.e., the lower primary surface 28) and through the upper surface 26 (e.g., into the adhesive 22).

Along with preconditioning the non-glass substrate 16, selecting and/or positioning moisture barriers, e.g., a lower moisture barrier 40 and an upper moisture barrier 44, within the non-glass substrate 16 such that they exhibit a moisture diffusivity that is comparable to or less than the moisture diffusivity through the flexible glass sheet 12, can ensure that defects in the adhesive 22 within the overall laminated glass structure 100b are eliminated or otherwise reduced to an acceptable level. These benefits are applicable to the laminated glass structure 100b as-manufactured and through its lifetime as subjected to environmental conditions including but not limited to temperature and/or humidity evolutions. Dual moisture barriers, e.g., lower and upper moisture barriers 40, 44, selected and positioned according to the foregoing principles are effective at controlling moisture ingress and egress within the non-glass substrate 16, particularly through the lifetime of the laminated glass structure 100b as it experiences various environmental conditions. Moreover, these barriers effectively prevent any residual moisture in the non-glass substrate 16, whether preconditioned or not, from reaching the adhesive 22 and coalescing into observable defects within the adhesive. Further, the moisture barriers 40, 44 are beneficially hidden or otherwise buried within the laminated glass structure 100b such that they do not detract from the aesthetics of the structure, affect its design flexibility in terms of possessing other decorative surfaces (e.g., on the upper and/or lower primary surfaces 26, 28), and/or impact the manufacturability and preparation of its final form (e.g., through cutting, sectioning, polishing and the like).

Compared to the laminated glass structure 100a (see FIG. 2) containing an upper moisture barrier 44 and free of a lower moisture barrier, the laminated glass structure 100b depicted in FIG. 3 containing a lower and an upper moisture barrier 40, 44 is particularly versatile from a manufacturing and shipment standpoint. Notably, the laminated glass structure 100b is resistant to moisture absorption as it may exist in an interim form during manufacturing before lamination of the flexible glass sheet 12 with the adhesive 22. In particular, the laminated glass structure 100b contains dual moisture barriers in proximity to the upper and lower primary surfaces 26, 28 of the non-glass substrate 16, which serve to balance moisture ingress and egress in the laminated glass structure before it has been laminated with a flexible glass sheet 12. Accordingly, the use of dual moisture barriers 40, 44 can serve to reduce the propensity of defects to form within the adhesive 22 of the laminated glass structure 100b. In particular, the dual barriers ensure that the non-glass substrate 16 has no residual moisture or a minimal amount of moisture prior to lamination of the flexible glass sheet 12 to the non-glass substrate 16 with the adhesive 22, which might otherwise trap any residual moisture within the adhesive 22 given the relatively low moisture diffusivity of the flexible glass sheet 12.

Referring again to moisture barriers 40, 44 of the laminated glass structure 100b depicted in FIG. 3, these barriers can have the same dimensions and composition as the upper moisture barrier 44 described earlier in connection with the laminated glass structure 100a depicted in FIG. 2. In certain aspects, the moisture barriers 40, 44 have the same or similar composition and/or thickness. In other implementations, the barriers 40, 44 have dissimilar compositions and/or thicknesses, for example, based on a desire for particular edge-on aesthetics for the laminated glass structure 100b.

Referring now to FIG. 3A, another exemplary embodiment of a laminated glass structure 100b is depicted in the form of a laminated glass structure having a high-pressure laminate (HPL). Unless otherwise noted, the laminated glass structure 100b depicted in FIG. 3A includes the same features as the laminated glass structure 100b depicted in FIG. 3. For example, the laminated glass structure 100b shown in FIG. 3A includes a non-glass substrate 16, a flexible glass sheet 12, a lower moisture barrier 40 and an upper moisture barrier 44. Further, the laminated glass structure 100b shown in FIG. 3A can exhibit the same functionality as the structure 100b depicted in FIG. 3, including optical clarity, adhesive defect resistance, moisture insensitivity and/or temperature insensitivity. In particular, the adhesive 22 in the laminated glass structure 100b is substantially defect free upon exposure to (a) a drying evolution at 70° C. for 24 hours; and/or (b) ambient temperature and humidity for 60 days. However, the non-glass substrate 16 of the laminated glass structure 100b depicted in FIG. 3A more particularly includes a stack 10 of polymer-impregnated papers, a lower moisture barrier 40, an upper moisture barrier 44, polymer-impregnated decorative papers 9, separate polymer-impregnated papers 11 and optional surface layers 8. In this configuration, the polymer-impregnated papers 11 are configured to assist or otherwise enable the joining of the polymer-impregnated decorative papers 9 to the lower and upper moisture barriers 40, 44, as shown in FIG. 3A. Still further, the non-glass substrate 16 is preconditioned at 70° C. for 96 hours prior to lamination of the upper primary surface 26 of the non-glass substrate 16 with the adhesive 22 to the flexible glass sheet 12.

In an exemplary embodiment, the laminated glass structure 100b has an overall thickness from about 4 mm to about 25 mm, and includes a non-glass substrate 16 in the form of an HPL with a stack 10 having about 1 to 100 phenolic resin-impregnated kraft papers, laminated under an above-ambient pressure. The lower and upper moisture barriers 40, 44 are in the form of an aluminum foil ranging in thickness from about 20 to 60 microns. Further, each of the polymer-impregnated decorative papers 9 is configured as a melamine-impregnated decorative kraft paper. As such, each of the papers 9 can include a solid color and/or decorative patterns. When patterns are employed in the decorative papers 9, an additional melamine-impregnated surface layer 8 can be added to either side of the HPL (i.e., at upper and/or lower primary surfaces 26, 28) to ensure that wear to the HPL does not result in a loss or degradation to the pattern(s) contained in the papers 9. Conversely, the surface layers 8 are unnecessary to include in the HPL for decorative papers 9 containing a solid color decorative aspect.

According to another embodiment of the disclosure, the laminated glass structures 100a, 100b (see FIGS. 2, 2A, 3 and 3A), and others consistent with these structures, can be fabricated according to an exemplary method that affords them with optical clarity, adhesive defect resistance, moisture insensitivity and/or temperature insensitivity. In particular, the method may include a step of laminating a stack of polymer-impregnated papers (e.g., stack 10) at an above-ambient pressure to form a non-glass substrate (e.g., non-glass substrate 16), the stack comprising an upper moisture barrier (e.g., barrier 44). Further, the method includes a step of preconditioning the non-glass substrate at 70° C. for at least 96 hours to define a preconditioned, non-glass substrate having an upper primary surface and a lower primary surface (e.g., primary surfaces 26, 28).

As outlined earlier, the preconditioning step serves to eliminate or otherwise reduce residual moisture and/or volatiles within the non-glass substrate prior to a subsequent lamination step. In certain aspects, the step of laminating the flexible glass sheet is conducted no more than 4 days after completion of the preconditioning step. This ensures that moisture (and other volatiles) does not reenter the non-glass substrate prior to the step of laminating the relatively low diffusivity, flexible glass sheet onto it with an adhesive. As understood by those with ordinary skill, additional steps can be taken during manufacturing to extend this period, provided that the preconditioned, non-glass substrate is maintained in controlled moisture- and volatile-limited environment prior to the subsequent step of laminating the glass sheet to the non-glass substrate with an adhesive.

The method of making the laminated glass structure further includes a step of laminating a glass sheet (e.g., flexible glass sheet 12) having at thickness of no greater than 0.3 mm to the upper primary surface of the preconditioned, non-glass substrate with an adhesive (e.g., adhesive 22) to form a laminated glass structure. Further, the upper moisture barrier is disposed at a selected depth from the upper primary surface of the preconditioned, non-glass substrate (e.g., during the step of laminating the stack of polymer-impregnated papers). In certain implementations, the step of laminating the glass sheet to the preconditioned, non-glass substrate with an adhesive is conducted in a moisture- and volatile-limited environment (e.g., under vacuum or an inert gas such as argon, nitrogen, helium or combinations thereof).

Ultimately, the laminated glass structures fabricated according to the foregoing method, or methods consistent with its principles, will exhibit optical clarity, adhesive defect resistance, temperature insensitivity and/or moisture insensitivity. In certain aspects, the laminated glass structures fabricated according to the method have an adhesive that is substantially defect free upon exposure of the laminated glass structure to a drying evolution at 70° C. for 15 days and/or ambient humidity and temperature for 60 days.

### Example 1

The following examples further demonstrate the embodiments of the disclosure. High pressure laminates (HPLs) were laminated to Corning® Willow® Glass (200 μm in thickness) with 3M™ 8215 optically clear adhesive (125 μm in thickness) according to processes as understood by those with ordinary skill in the field of the disclosure (“Comp. Exs. 1A, 1B, and 1C”). As noted below in Table 1, Comp. Ex. 1A is indicative of a laminated glass structure with a conventional HPL with no moisture barriers and no preconditioning. Comp. Ex. 1B is also indicative of a laminated glass structure with a conventional HPL with no moisture barriers, but preconditioned at 70° C. for 96 hours prior to lamination to the Corning® Willow® Glass. Further, Comp. Ex. 1C is indicative of a laminated glass structure with a conventional HPL having dual moisture barriers and no preconditioning. As shown in Table 1, all of these samples, Comp. Exs. 1A-1C, exhibited bubbles in the adhesive after the listed environmental exposure.

Laminated glass structures with HPLs with dual moisture barriers as the non-glass substrates were prepared comparably to the Comp. Ex. 1C sample, but were also processed with a preconditioning of the non-glass substrate. These samples (“Exs. 1, 2 and 3”), exemplary of the laminated glass structures of the disclosure, exhibited no bubbles in the adhesive after the listed environmental exposures. As such, the combination of the preconditioning the non-glass substrate and the use of moisture barriers, particularly in proximity to the adhesive, serves to ensure that bubbles are not formed in the adhesive as-manufactured and after certain environmental exposures.

TABLE 1

| | Non-Glass | | | |
|---|---|---|---|---|
| | Substrate | Non-glass substrate | Environmental | Bubbles in |
| Example | Description | precondition | Exposure Condition | Adhesive? |
| Comp. Ex. 1A | Conventional HPL | None | Ambient - 60 days | Yes |
| Comp. Ex. 1B | Conventional HPL | 70° C. for 96 hours | 70° C. for 9-10 days | Yes |
| Comp. Ex. 1C | HPL with 2 Al foils as | None | 70° C. for 1 day | Yes |
| | upper and lower | | | |
| | moisture barriers | | | |
| Ex. 1 | HPL with 2 Al foils as | 70° C. for 96 hours | 70° C. for 15 days | No |
| | upper and lower | | | |
| | moisture barriers | | | |
| Ex. 2 | HPL with 2 Al foils as | 70° C. for 96 hours; and | 70° C. for 15 days | No |
| | upper and lower | 23° C./50% RH for 96 hours | | |
| | moisture barriers | | | |
| Ex. 3 | HPL with 2 Al foils as | 70° C. for 96 hours | 40° C./95% RH for 8 days; | No |
| | upper and lower | | and 70° C. for 15 days | |
| | moisture barriers | | | |

It should be emphasized that the above-described embodiments of the present disclosure, including any embodiments, are merely possible examples of implementations, merely set forth for a clear understanding of various principles of the disclosure. Many variations and modifications may be made to the above-described embodiments of the disclosure without departing substantially from the spirit and various principles of the disclosure. All such modifications and variations are intended to be included herein within the scope of this disclosure and the present disclosure and protected by the following claims.

What is claimed is:

1. A laminated glass structure, comprising:
a non-glass substrate comprising one or more layers of polymer-impregnated paper, an upper primary surface and a lower primary surface; and
a flexible glass sheet having a thickness of no greater than 0.3 mm laminated to the upper primary surface of the non-glass substrate with an adhesive,
wherein the non-glass substrate comprises an upper moisture barrier at a selected depth from the upper primary surface.

2. The structure according to claim 1, wherein the non-glass substrate is preconditioned at 70° C. for 96 hours prior to lamination of the flexible glass sheet to the upper primary surface of the non-glass substrate.

3. The structure according to claim 1, wherein the adhesive is substantially defect free upon exposure of the laminated glass structure to at least one of:
(a) a drying evolution at 70° C. for 15 days; or
(b) ambient humidity and temperature for 60 days.

4. The structure according to claim 1, wherein the upper moisture barrier comprises an aluminum foil having a thickness from about 20 to about 60 microns.

5. The structure according to claim 1, wherein:
the upper moisture barrier has a thickness from about 20 to about 60 microns;
the upper moisture barrier comprises a material selected from the group consisting of a glass, a polymer, a metal, a ceramic, and a combination thereof; and
the upper moisture barrier exhibits a moisture diffusivity of no more than 10,000 times the moisture diffusivity of the flexible glass sheet at 45° C.

6. (canceled)

7. The structure according to claim 1, wherein a total thickness of the non-glass substrate, the flexible glass sheet and the adhesive is from about 4 mm to about 25 mm.

8. The structure according to claim 1, wherein the upper and lower primary surfaces each comprise a melamine-impregnated decorative layer.

9. The structure according to claim 1, wherein the non-glass substrate comprises an upper portion in proximity to the upper primary surface and a lower portion in proximity to the lower primary surface, and the upper portion exhibits lower moisture diffusivity than the lower portion.

10. The structure according to claim 1, wherein the non-glass substrate comprises a lower moisture barrier at a selected depth from the lower primary surface.

11. (canceled)

12. The structure according to claim 10, wherein:
each of the upper moisture barrier and the lower moisture barrier has a thickness from about 20 to about 60 microns;
each of the upper moisture barrier and the lower moisture barrier comprises a material selected from the group consisting of a glass, a polymer, a metal, a ceramic, and a combination thereof; and
each of the upper moisture barrier and the lower moisture barriers exhibits a moisture diffusivity of no more than 10,000 times the moisture diffusivity of the flexible glass sheet at 45° C.

13. A laminated glass structure, comprising:
a non-glass substrate comprising a high pressure laminate (HPL), an upper primary surface and a lower primary surface; and
a flexible glass sheet having a thickness of no greater than 0.3 mm laminated to the upper primary surface of the non-glass substrate with an adhesive,
wherein the non-glass substrate comprises an upper moisture barrier at a selected depth from the upper primary surface, the moisture barrier having a thickness from about 20 microns to about 60 microns,
wherein a total thickness of the non-glass substrate, the flexible glass sheet and the adhesive is from about 4 mm to about 25 mm, and
further wherein the adhesive is substantially defect free upon exposure of the laminated glass structure to (a) a drying evolution at 70° C. for 15 days; and (b) ambient humidity and temperature for 60 days.

14. The structure according to claim 13, wherein the non-glass substrate is preconditioned at 70° C. for 96 hours prior to lamination of the flexible glass sheet to the upper primary surface of the non-glass substrate.

15. (canceled)

16. The structure according to claim 13, wherein:
the upper moisture barrier comprises a material selected from the group consisting of a glass, a polymer, a metal, a ceramic, and a combination thereof; and
the upper moisture barrier exhibits a moisture diffusivity of no more than 10,000 times the moisture diffusivity of the flexible glass sheet at 45° C.

17. The structure according to claim 13, wherein the upper and lower primary surfaces each comprise a melamine-impregnated decorative layer.

18. The structure according to claim 13, wherein the non-glass substrate further comprises an upper portion in proximity to the upper primary surface and a lower portion in proximity to the lower primary surface, and the upper portion exhibits lower moisture diffusivity than the moisture diffusivity of the lower portion.

19. A method of making a laminated glass structure, comprising the steps:
preconditioning a non-glass substrate at 70° C. for at least 96 hours to define a preconditioned, non-glass substrate, the non-glass substrate comprising a stack of polymer-impregnated papers and an upper moisture barrier, and having an upper primary surface and a lower primary surface; and
laminating a flexible glass sheet having a thickness of no greater than 0.3 mm to the upper primary surface of the preconditioned, non-glass substrate with an adhesive to form the laminated glass structure,
wherein the upper moisture barrier is at a selected depth from the upper primary surface of the preconditioned, non-glass substrate.

20. The method according to claim 19, further comprising the step:
laminating the stack of polymer-impregnated papers at an above-ambient pressure to form the non-glass substrate.

21. (canceled)

22. The method according to claim 19, wherein the adhesive is substantially defect free upon exposure of the laminated glass structure to at least one of:
(a) a drying evolution at 70° C. for 15 days; or
(b) ambient humidity and temperature for 60 days.

23. The method according to claim 19, wherein the upper moisture barrier comprises an aluminum foil having a thickness from about 20 to about 60 microns.

24. The method according to claim 19, wherein a total thickness of the preconditioned, non-glass substrate, the flexible glass sheet and the adhesive is from about 4 mm to about 25 mm.
